(19) United States
(12) Patent Application Publication
(10) Pub. No.: US 2014/0085878 A1
(43) Pub. Date: Mar. 27, 2014

(54) CYLINDRICAL FLASHLIGHT HAVING A ROLL-AWAY PREVENTION MECHANISM

(71) Applicant: Andre Kunzendorf, Wuppertal (DE)

(72) Inventor: Andre Kunzendorf, Wuppertal (DE)

(21) Appl. No.: 14/007,204

(22) PCT Filed: May 4, 2012
(86) PCT No.: PCT/DE2012/000470

§ 371 Date: Sep. 24, 2013

(30) Foreign Application Priority Data
Jun. 8, 2011 (DE) 10 2011 103 653.2

(51) Int. Cl. F21L 4/00

(52) U.S. Cl. CPC F21L 4/005
USPC 362/202

(57) ABSTRACT

The present invention relates to a cylindrical flashlight and a ring element for use as a roll-away safeguard of a cylindrical flashlight. In order to prevent a cylindrical flashlight from rolling away, the invention proposes a cylindrical flashlight having a ring element that is connected to the flashlight and has radially protruding elevations which have surface sections that are arranged at a distance from the surface of the cylindrical flashlight in some areas in the assembled state. Also proposed is a ring element for use as a roll-away safeguard of a cylindrical flashlight, which can be detachably connected to the flashlight and has radially protruding elevations which have surface sections that are arranged at a distance from the cylindrical surface of the flashlight in the assembled state.

The present invention relates to a cylindrical flashlight and to a ring element for use as a roll-away safeguard of a cylindrical flashlight.

Flashlights can be obtained in virtually any design desired. However, cylindrical flashlights have primarily penetrated the market, since, on the one hand, they can be produced simply and, on the other hand, are very robust because of their design. It has proven particularly practical here to provide the individual component parts of the flashlight, such as the flashlight housing, the end cap and the flashlight head, with appropriate threaded sections, so that these parts can be joined together simply and quickly. Furthermore, cylindrical flashlights lie well in the hand and give the user a good haptic feeling.

However, cylindrical flashlights disadvantageously tend to roll away when they are put down on an inclined surface or if they are lying on a shelf in an automobile, train or another means of transportation which is braked or accelerated. For these reasons, the lamp head of the flashlight described in DE 2950850 [U.S. Pat. No. 4,307,439] is formed as an equilateral polygon in order that the flashlight does not roll when it is laid down. Alternatively, ribs extending in the axial direction can also be provided.

The disadvantage with such a configuration is that not every buyer of flashlights needs the latter for the same intended purpose, so that the asymmetric configuration of flashlights that differs from the cylindrical shape can also be undesired. Above all outdoors, where flashlights are conveyed all day in the rucksack or other packing devices and are used only infrequently, such a flashlight provides edges and corners on which sensitive material of the other stowed items of baggage may wear away. Furthermore, flashlights which have a design differing from a cylindrical shape are comparatively heavier, which has likewise proven to be disadvantageous in particular outdoors, where attention is meanwhile paid to every gram.

For these reasons, many buyers must disadvantageously obtain two different flashlights, which are each constructed for different intended purposes, or decide between two flashlights, neither of which is adapted optimally for the envisaged intended use.

It is therefore the object of the present invention to devise a possible way of being able to adapt a flashlight to the required conditions and, in particular, to form a flashlight optionally with or without a roll-away safeguard.

This object is achieved by the cylindrical flashlight as claimed in claim 1 and by the ring element as claimed in claim 6.

According to a first aspect of the invention, the cylindrical flashlight has at least one ring element that is connected to the flashlight and has radially protruding elevations which have surface sections that are arranged at a distance from the surface of the cylindrical flashlight in some areas in the assembled state.

According to a further aspect of the invention, the ring element for use as a roll-away safeguard of a cylindrical flashlight can be detachably connected to the flashlight and has radially protruding elevations which have surface sections which are arranged at a distance from the cylindrical surface of the flashlight in the assembled state. The surface sections serve as a contact surface, so that a flashlight with ring element that is laid down cannot roll away unintentionally even if the supporting surface is moved or it is inclined. However, if the user will not use the flashlight for a relatively long time period such that undesired rolling away is to be feared, said user can remove the ring element from the flashlight, which means the latter once more has a cylindrical shape. Conversely, the ring element can also be fixed to the flashlight quickly again, which means the latter fulfills its function as a roll-away safeguard.

Preferred embodiments of the invention will be described below and in the sub-claims.

According to a first preferred refinement of the invention, the flashlight has a flashlight housing which, at the rear, is detachably connected to an end cap and/or, at the front, is detachably connected to a lamp head, wherein the end cap and/or the lamp head is/are preferably connected to the flashlight housing by a threaded connection. Alternatively or in addition to this, the lamp head can also be connected indirectly to the flashlight housing via a lamp head neck, where a threaded connection is likewise preferably provided between the lamp head and the lamp head neck. A flashlight built up in this way can be produced simply and assembled quickly, which is primarily advantageous when the ring element is to be connected to the flashlight or it is to be removed from the flashlight. This is because the ring element is preferably mounted with a form fit between the flashlight housing and the end cap or between the flashlight housing and the lamp head. In the case of the alternative refinement having a flashlight head and a lamp head neck, the ring element can optionally also be arranged between these components. Furthermore, it is also possible for two ring elements to be fixed to a flashlight at different points.

According to a further preferred embodiment, the ring element is designed to be L-shaped in cross section and has a sub-region which engages around the flashlight in the assembled state, while the other sub-region is designed as a stop face for the end side of the end cap, of the flashlight housing or of the lamp head. This makes it possible to keep the sub-region which is used as a stop face as small as possible, in order that the components of the flashlight can be joined together virtually to such an extent as would be possible without the interposed ring element, which means the function of the flashlight is not impaired. At the same time, the size of the contact face, that is to say the part which engages around the flashlight, is not restricted, which means that the optimal size of the ring element and therefore of the contact face can be chosen freely.

According to a further preferred embodiment of the present invention, the ring element is produced in one piece from aluminum or plastic, which reduces both the production costs and the weight of the flashlight.

The surface sections of the elevations are preferably designed as contact faces; in the case of an aluminum ring element, these surface sections can also be provided with a plastic coating, which means that the flashlight is effectively prevented from sliding away.

Practical refinements and further preferred embodiments of the present invention will be explained below by using the figures, in which:

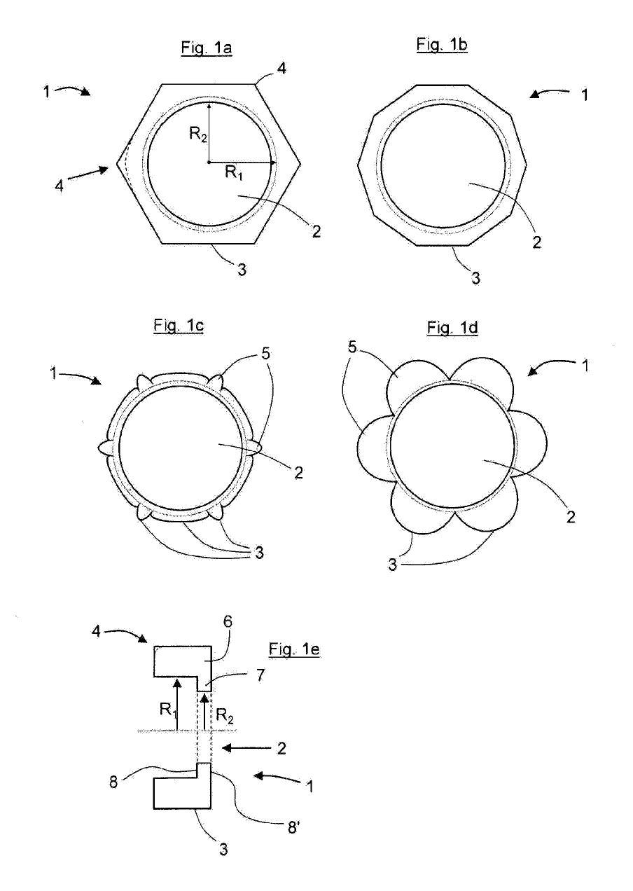

FIGS. 1a to d show different embodiments of a ring element;

FIG. 1e shows a cross-sectional view of a ring element;

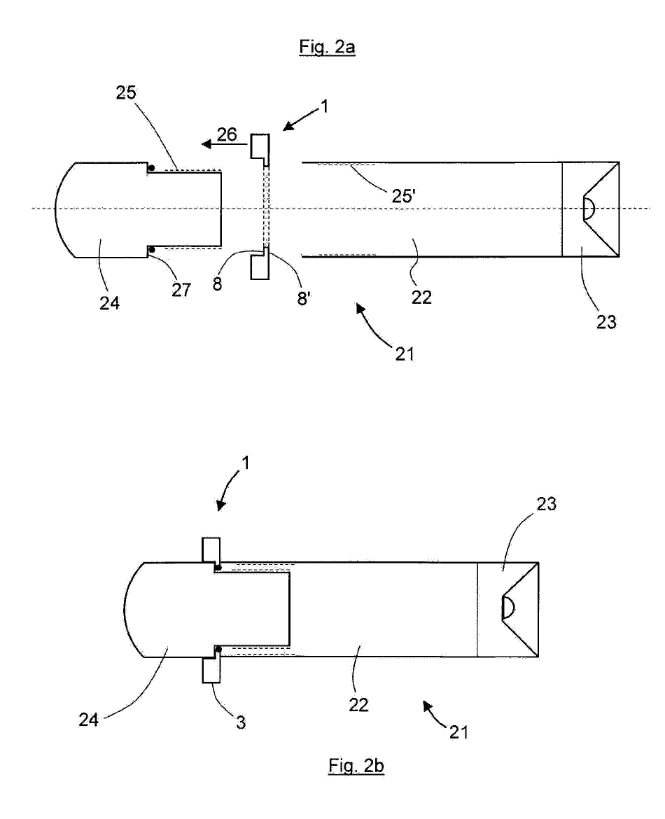

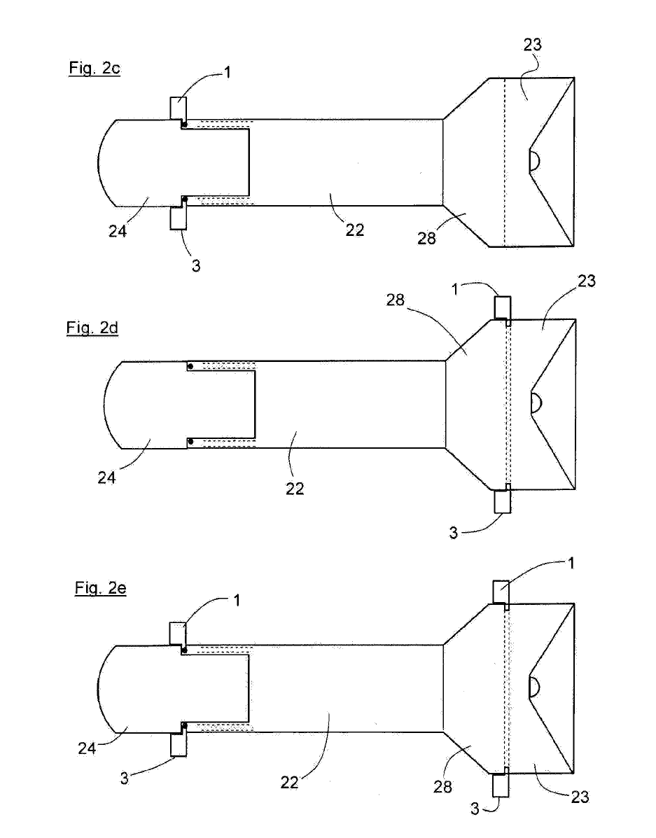

FIG. 2a shows an exploded illustration of a flashlight having a ring element and

FIGS. 2b to 2e each show schematic illustrations of flashlights having mounted ring elements.

The ring element 1 used as a roll-away safeguard has a circular guide hole 2. The circumference of the ring element 1 is configured so as to differ from a circular shape and has surface sections which are formed as a contact face 3. Different geometries of circumferential lines are provided, a polygonal configuration, as illustrated in FIGS. 1a and 1b, for example, being preferred. FIG. 1a shows an embodiment having six contact faces 3 and FIG. 1b one having ten contact faces 3. The fewer contact faces 3 are provided on a symmetrical ring element 1, the greater is the width b of the contact faces 3, which means the support for the flashlight is comparatively more stable. However, given a configuration with comparatively few contact faces 3, the edges at the corners 4 are also more sharply configured, which means the risk of damage to other objects is increased. Therefore, according to a preferred embodiment, the edges 4 can also be rounded off (arrow 5).

In addition to the substantially polygonal shape (FIGS. 1a, b), other designs of a ring element 1 are also conceivable, for example those in which the contact faces 3 are formed by hemispherical or rib-like elevations 5. Embodiments of this type are visually appealing and in addition give the user an improved haptic feel.

The ring element 1 is designed to be L-shaped in cross section (FIG. 1e) and has an outer sub-region 6 which, in the assembled state (FIGS. 2b to 2e), embraces the flashlight 21. To this end, the outer sub-region 6 has a radius R1 which is dimensioned such that it can be pushed onto a corresponding section of the flashlight 21. The inner sub-region 7 of the ring element 1 is formed as a stop face 8, 8′ for the parts of the flashlight 21, between which the ring element 1 is supported by a form fit in the assembled state (FIGS. 2b to 2e). To this end, the inner sub-region 7 of the ring element 1 has a radius R2 which is dimensioned such that an angular stop face 8, 8′ for the end sides of the flashlight 21 is produced.

FIGS. 2a to 2d show various practical embodiments of a flashlight 21 with a ring element 1 arranged thereon, FIG. 1a showing an exploded illustration. The flashlights 21 have a substantially cylindrical shape and comprise a flashlight housing 22, a lamp head 22 and an end cap 24, which each have appropriate threaded sections 25, 25′. As illustrated by way of example in FIG. 2a, the ring element 1 is dimensioned such that it can be guided over the threaded section 25 in the direction of the arrow 26 until the stop face 8′ is in contact with the stop face 27 on the end-cap side. By means of then screwing on the flashlight housing 22, the ring element 1 is fixed with a form fit.

FIGS. 2b and 2c show different flashlights 21, the ring element 1 in each case being mounted between the end cap 24 and the flashlight housing 22. The flashlight according to FIGS. 2c to e has a lamp head neck 28 in addition to the lamp head 23, between which a possibly comparatively larger ring element 1 can likewise be arranged. FIG. 2d shows an embodiment having a ring element 1 between the lamp head 23 and the flashlight neck 28, and FIG. 2e shows one in which a ring element 1 is arranged both between the lamp head 23 and the lamp head neck 28 and between the flashlight housing 22 and the end cap 24.

List of designations

1 Ring element
2 Guide hole
3 Contact face
4 Rounded corner
5 Elevation
6 Outer sub-region
7 Inner sub-region
8, 8′ Stop face
21 Flashlight
22 Flashlight housing
23 Lamp head
24 End cap
25, 25′ Threaded section
26 Direction of arrow
27 Stop face
28 Lamp head neck
B Width of the contact face
R1 Radius of the outer sub-region
R2 Radius of the inner sub-region

1. A cylindrical flashlight comprising at least one ring element that is detachably connected to the flashlight and has radially protruding elevations which have surface sections that are arranged at a distance from the surface of the cylindrical flashlight in some areas in the assembled state.

2. The cylindrical flashlight as claimed in claim 1, further comprising a flashlight housing which, at the rear, is detachably connected to an end cap or, at the front, is detachably connected to a lamp head, wherein the end cap or the lamp head is/are preferably connected to the flashlight housing by a threaded connection.

3. The cylindrical flashlight as claimed in claim 1, wherein the ring element for the detachable fixing to the flashlight is mounted with a form fit between
a) the flashlight housing and the end cap or
b) between the flashlight housing and the lamp head.

4. The cylindrical flashlight as claimed in claim 1, wherein the ring element is designed to be L-shaped in cross section and has a sub-region which engages around the flashlight in the assembled state, while the other sub-region is designed as a stop face for the end side
a) of the end cap,
b) of the flashlight housing or
c) of the lamp head.

5. The cylindrical flashlight as claimed in claim 1, wherein
a) the elevations are designed to be hemispherical or semi-cylindrical, or
b) the ring element has a polygonal circumferential line.

6. A ring element for use as a roll-away safeguard of a cylindrical flashlight,
wherein
the ring element can be detachably connected to the flashlight and has radially protruding elevations which have surface sections which are arranged at a distance from the cylindrical surface of the flashlight in the assembled state.

7. The ring element as claimed in claim 6, wherein the ring element is designed to be L-shaped in cross section and has a sub-region which engages around the flashlight in the assembled state, while the other sub-region is designed as a stop face for
a) the end side of the end cap,
b) of the flashlight housing or
c) of the lamp head.

8. The ring element as claimed in claim 6, wherein
a) the elevations are designed to be hemispherical or semi-cylindrical, or
b) the ring element has a polygonal circumferential line.

9. The ring element as claimed in claim 6, wherein the ring element consists of aluminum or plastic in one piece.

10. The ring element as claimed in claim 6, wherein the surface sections of the elevations are designed as contact faces.
